(19) United States
(12) Patent Application Publication
(10) Pub. No.: US 2020/0175577 A1
(43) Pub. Date: Jun. 4, 2020

(54) INTEGRATED ANALYTICAL AND IMAGE-BASED PLANNING

(71) Applicant: SAP SE, Walldorf (DE)

(72) Inventors: Ruturaj MODY, Montreal (CA); Pete Kuhn, Konstanz (DE)

(21) Appl. No.: 16/208,957

(22) Filed: Dec. 4, 2018

(51) Int. Cl. G06Q 30/06; G06Q 10/06; G06Q 30/02; G06F 16/28

(52) U.S. Cl. CPC G06Q 30/0643; G06Q 10/06393; G06Q 30/0204; G06F 16/285; G06Q 30/0201

(57) ABSTRACT

Disclosed herein are system, method, and computer program object embodiments for creating an assortment of objects to be made available to one or more entities. The assortment of objects including at least one or more of a plurality of objects. An embodiment operates by receiving information pertaining to a plurality of entities and to the plurality of objects. Based on the information pertaining to the plurality of entities, one or more entities for the assortment of objects is determined. Thereafter, a module representing a selection of the assortment of objects for at least one of the plurality of entities is created. The module and the information pertaining to at least one of the objects are presented to the planner, and at least one of the objects is permitted to be assigned to the module by the planner.

### BACKGROUND

Merchandise planning is an important tool for a company's bottom line. If done correctly, merchandise planning allows companies to purchase an appropriate amount of objects in an accurate assortment for their stores. If not done correctly, merchandise planning may result in companies having an overflow of objects and/or an assortment of objects that do not attract customers to their stores, which in either case may drastically affect their bottom line. Therefore, companies rely on highly skilled merchandise planners to select the right amount and assortment of objects for each of their stores. These merchandise planners are left with the difficult task of balancing their emotional desire in creating an assortment of objects with the company's business objectives.

### BRIEF DESCRIPTION OF THE DRAWINGS

The accompanying drawings are incorporated herein and form part of the specification.

FIG. 1 illustrates a block diagram of a system for digitally creating assortments of objects for entities, according to some embodiments.

FIGS. 2-11 illustrate example interfaces for digitally creating assortments of objects for entities, according to some embodiments.

FIG. 12 illustrates a flowchart for digitally creating assortments of objects for entities, according to some embodiments.

FIG. 13 illustrates an example computer system useful for implementing various embodiments.

In the drawings, like reference numbers generally, indicate identical or similar elements. Additionally, generally, the left-most digit(s) of a reference number identifies the drawing in which the reference number first appears.

### DETAILED DESCRIPTION

Provided herein are system, apparatus, device, method and/or computer program object embodiments, and/or combinations and sub-combinations thereof, for digitally creating assortments of objects for entities. The creation of the assortments of objects may be based on a number of interfaces defining properties of the objects and/or entities. As such, the objects to be made available, and/or entities to receive the assortments of objects, may be controlled by a business professional and/or a planner. Moreover, the planner may have planning goals in creating the assortments of objects based on key performance indicators (KPIs) of the entities. The planner may then track their progress of the planning goals while creating the assortments of objects.

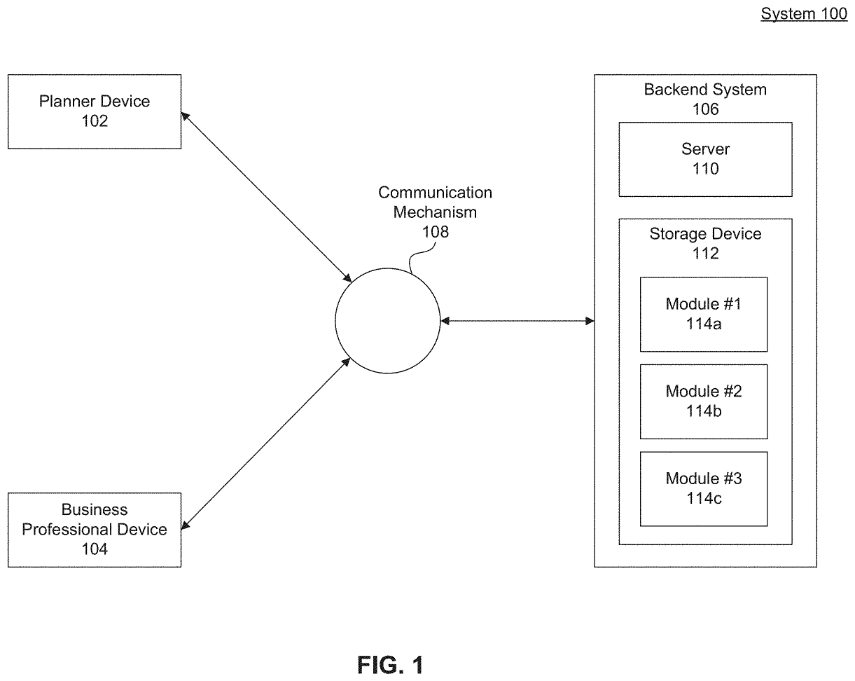

FIG. 1 illustrates a system 100 for digitally creating assortments of objects for entities. The system 100 may include a planner device 102, a business professional device 104, a backend system 106, each of which may be in communication with each other via a communication mechanism 108. The planner device 102 may be used by a planner designated to create assortments of objects for entities. The business professional device 104 may be designated for a business professional—different than the planner of the planner device 102—to assign the planner to create assortments of objects for the entities. As such, the object may be any type of material thing that can be touched (e.g., a product). Moreover, the business professional may be an individual in charge of providing strategic business goals The entities may be or refer to a place of business (e.g., a retail store) or an individual. The communication mechanism 108 may include a public and/or private network (wired or wireless), such as a local area network (LAN), a wide area network (WAN), the Internet, a virtual LAN (VLAN), an enterprise LAN, a virtual private network (VPN), an enterprise IP network, or any combination thereof.

The backend system 106 may include a server 110 and a storage device 112. The server 110 may manage communication between the planner device 102 and the business professional device 104. The storage device 110 may include a plurality of modules 114. In some embodiments, module 114a may store information relating to objects (e.g., available size, available quantities, cost, brand name, type, genre). Module 114b may store information relating to entities (e.g., location, type, genre, goal demographic, goal gender, goal age group, etc.). Module 114c may store information relating to business goals (e.g., margins, key performance goals, past performance, etc.). As such, in managing communication, server 110 may create workspaces for planners to create assortments of objects for the entities based on planner input, as will be described in detail below.

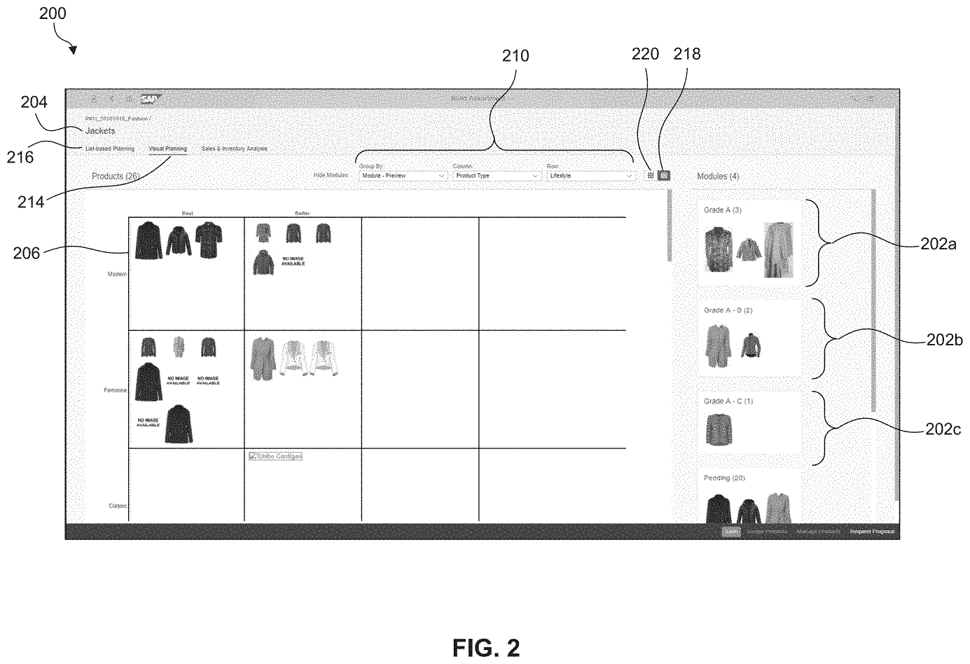

Referring now to FIG. 2, an interface 200 for a planner to digitally create assortments of objects for entities is illustrated. The interface may provide images of objects 206 for a particular category 204. As such, the interface 200 may include modules 202 and a plurality of objects 206 available for the planner for assigning to at least one module 202. Each module 202 may represent a different assortment of objects selected by the planner. As will be described in more detail below, each module 202 will be for a single entity or a cluster of entities. Moreover, although not illustrated, the interface 200 may present a search bar to permit the planner to search for a particular object. It is noted that some of the figures refer to colors, such as FIG. 2. But colors may vary among embodiments and implementations and are not important for understanding the metes and bounds of this disclosure. Accordingly, colors are shown in grayscale in the figures. But practical implementations may show actual colors, as will be appreciated by persons skilled in the relevant art(s).

Referring back to FIG. 1, as will be explained in more detail below, for the business professional at the business professional device 104 to assign a planner to create assortments of objects for entities, the business professional and/or planner may select one or more of—(i) a plurality of objects available for selection by the planner, (ii) entities to designate for the planner, and (iii) business goals for the planner. As such, an assortment of objects may be provided for a single entity or a cluster of entities. Along these lines, multiple assortments of objects can be provided for a single entity or a cluster of entities. The cluster of entities can be grouped based on common characteristic, such as a similar geographical region, selling similar type merchandise, and/or having a similar goal audience.

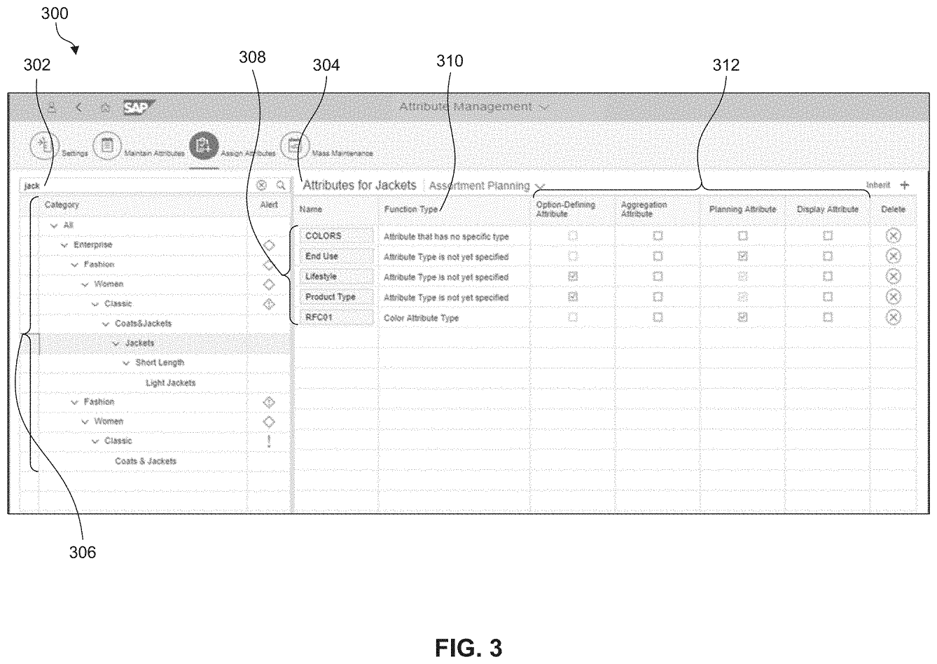

FIGS. 3-11 illustrate interfaces to permit a planner to digitally create of assortments of objects for entities. The interfaces may be presented to a business professional and/or a planner. The interfaces may be provide in any sequence and are not restricted to the sequence discussed herein. Moreover, although displayed and discussed in detail, one or more of the interfaces may not be required for permitting the planner to digitally create the assortments of objects for the entities.

FIG. 3 illustrates an interface 300 for defining attributes of objects. The interface 300 may include a first window 302 and a second window 304. The first window 302 may present an organizational hierarchy of objects 306, which includes categories, subcategories, segments, subsegments, and/or sub-subsegments. For example, as illustrated, the category “Fashion” may have the subcategory “Women,” which may have the segment “Classic.” The segment “Classic” may have the subsegment “Coats and Jackets,” which has the subsegment “Coats and Jackets.” The subsegment “Coats and Jackets” may have the sub-subsegment “Jacket.”

Moreover, for each group of objects in the hierarchy of objects 306, the second window 304 may present a list of associated attributes 308, a function type 310 for each attribute 308, and behaviors 312 for each attribute 310. The attributes 308 may be any property relating to the object. For example, as illustrated, the attributes for a jacket may be a color of the jacket, an end use of jacket, a lifestyle associated with the jacket, a product type of the jacket, and RFC01 of the jacket. The function type 310 may represent properties of a object associated with the attributes. For example, for jackets, the function type may define sizes of the jacket (e.g., a U.S. size or a E.P. size).

Moreover, the behaviors 312 may define the attributes 308. As illustrated, the behaviors 312 may include an option-defining attribute, an aggregation attribute, a planning attribute, and/or a display attribute. The option-defining attribute behavior may determine the object attributes relevant to defining a strategic planning goal. As such, the option-defining attribute behavior may allow users to have a mix of objects. The aggregation attribute behavior may provide a separate aggregation level for all object variants within a generic object that has this quality. As such, the aggregation attribute behavior may only be assigned to one attribute. The planning attribute behavior may permit key performance indicators of the associated object to be utilized. Thus, the attributes that have an option-defining attribute behavior may automatically have the planning attribute behavior. The display attribute behavior may permit the associate attributes to be for display only. As such, the associated attributes may not be used for planning purposes.

Along these lines, when the business professional assigns attributes to a subcategory of objects (e.g., subcategories, segments, subsegments, and/or sub-subsegments), those attributes may be assigned to subcategories and/or categories above the assigned category in the hierarchy of categories of objects 306. Moreover, by assigning attributes to subcategories and/or categories of objects, the business professional may select relevant value combinations in line with the types of objects offered to customers for the selected year, season, collection, and/or theme. Accordingly, the interface 300 may provide flexibility by allowing the business professional to drive the planning process based on characteristics of each object/subcategory/category.

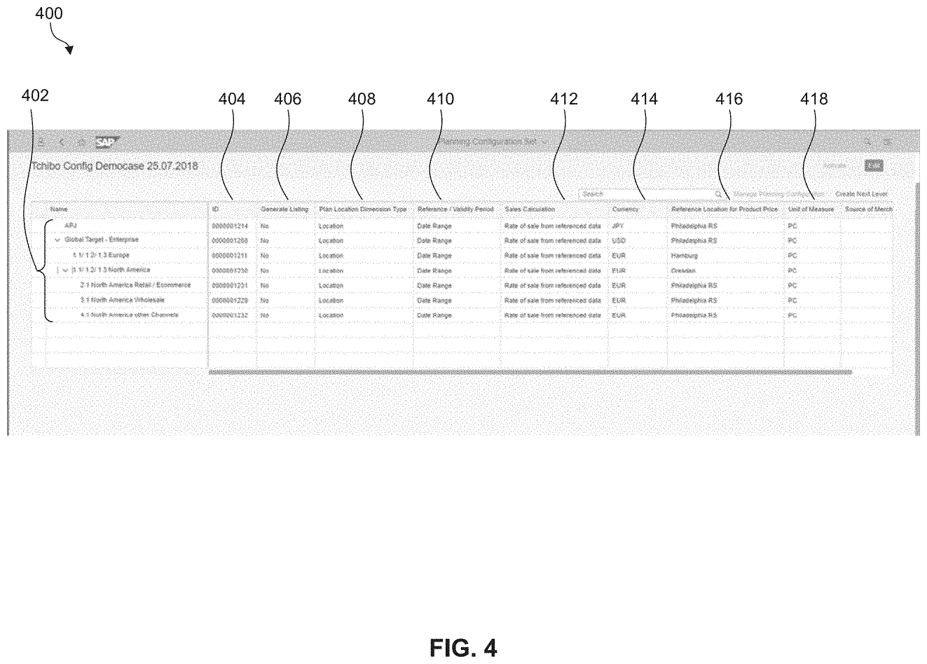

FIG. 4 illustrates an interface 400 for setting boundaries for assortments of objects. The interface 400 may include planning configurations 402 (e.g., “Global Target-Enterprise). Each planning configuration 402 may include a hierarchy of categories and/or subcategories. As such, the groups of entities may be grouped together based on their geographical location (e.g., North America, Europe) and/or channel type (e.g., retail, wholesale, e-commerce). For example, as illustrated, entities may be grouped based on their geographical location—“Europe” and “North America.” Moreover, each geographical group of entities may be subdivided based on their sales channel type—“North America Retail/Ecommerce,” “North America Wholesale,” and “North America other Channels.”

Furthermore, for each category or subcategory of the hierarchy of entities 402, the interface 400 may include an identification number (“ID”) 404, a determination whether to generate the listing (“Generate Listing”) 406, a plan location dimension type (“Plan Location Dimension Type”) 408, a reference/validity period (“Reference/Validity Period”) 410, a sales calculation (“Sales Calculation”) 412, a currency (“Currency”) 414, a reference location for object price (“Reference Location for Product Price”) 416, and/or a unit of measure (“Unit of Measure”) 418. As such, for each category or subcategory in the hierarchy of entities 402, the business professional and/or the planner may determine a listing 406, a plan location dimension type 408, a reference/validity period 410, a sales calculation 412, a currency 414, a reference location for object price 416, and/or a unit of measure 418. The listing 406 may refer to whether a planner is to create an assortment of objects, which may be propagated further to create an object listing in the stores (e.g., “Yes” or “No”). The plan location dimension type 408 may relate to whether each category or subcategories is planned on the detailed level of a single entity or a cluster of entities (e.g., “Location” or “Cluster”). The reference/validity period 410 may relate to a period for which the planners are to select the plurality of objects (e.g., “Season”). The sales calculation 412 may refer to how to calculate the business goals. The currency 414 may relate to a type of currency taken in the goal market and/or to calculate business goals. The reference location for object price 416 may be a single entity or a cluster of entities for which the object price to include in business goals is based from.

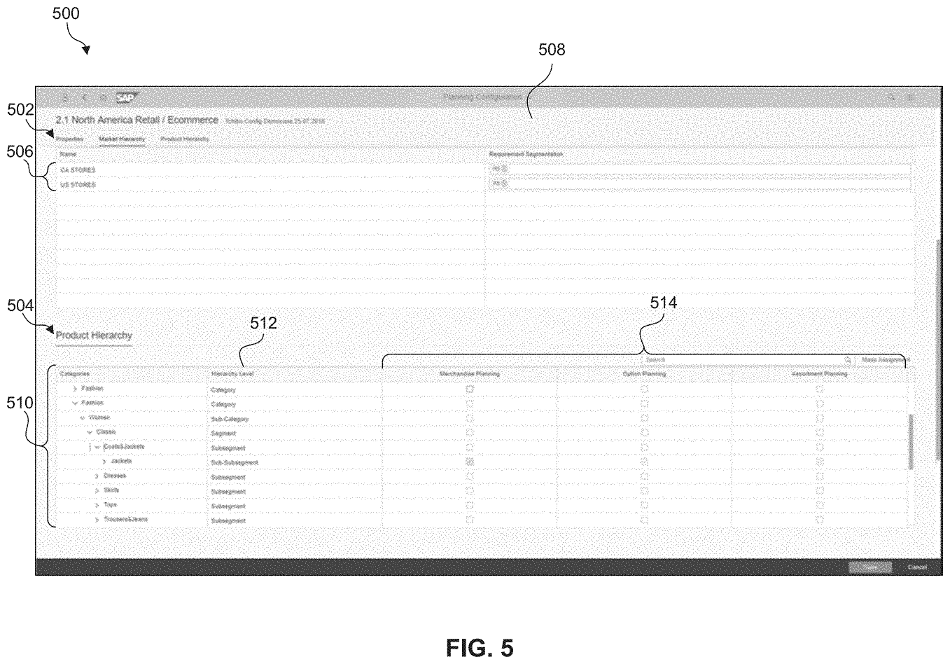

FIG. 5 illustrates an interface 500 for specifying the objects available for a planner to create assortments of objects for the group of entities “North America Retail/Ecommerce” illustrated in FIG. 4. The interface 500 may include a first window 502 and a second window 504. The first window 502 may include subgroups of entities 506 within the groups of entities “North America Retail/Ecommerce” and a requirement segmentation 508 for the subgroup of entities 506 North America Retail/Ecommerce”. As illustrated, subgroups of entities 504 for the group of entities “North America Retail/Ecommerce” may be “CA STORES” and “US STORES.”

The second window 504 may include a hierarchy of objects 510, an indication of the hierarchy level 512 for each category in the hierarchy of objects 510, and assortments of objects for the planner to create 514 for each category in the hierarchy of objects 510 for for the subgroup of entities. The second window may permit selection of specific objects within the heirarchy of objects 510 for different assortments of objects.

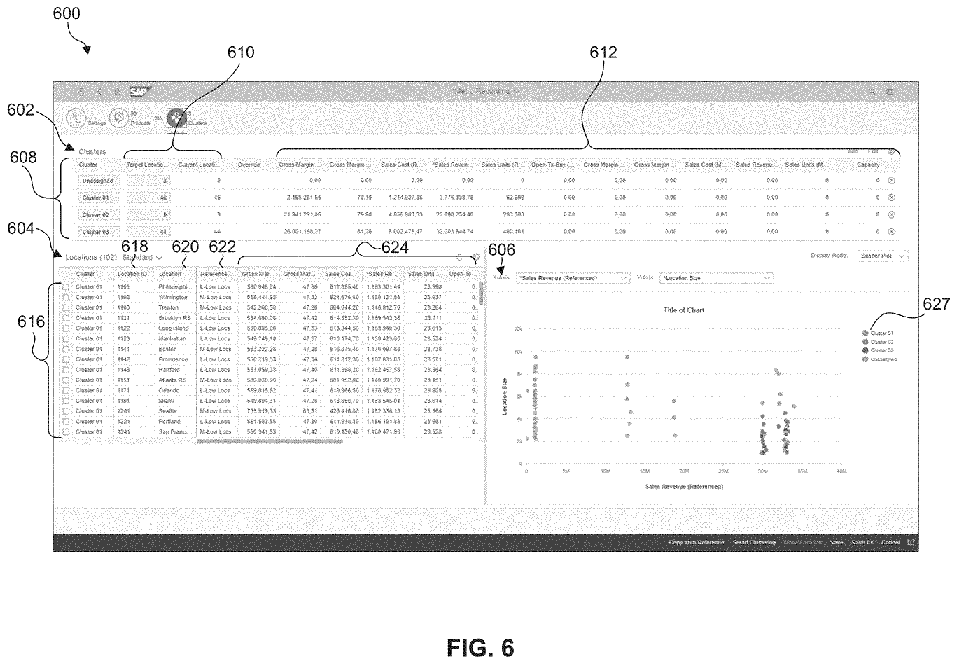

FIG. 6 presents an interface 600 for creating clusters of entities for allocation of assortments of objects for entities in a particular geographical region and/or channel type as described in FIG. 4. The interface 600 presents a first window 602, a second window 604, and a third window 606. The first window 602 may present a list of clusters 608 for a particular group of entities (e.g., “North America Retail/Ecommerce”) or subgroup of entities (e.g., CA STORES). The clusters may be created manually or by a clustering algorithm. As such, the cluster may be defined by a target location count. The algorithm may be based on location KPIs and/or a predetermined number of desired clusters.

The first window 602 may present for each cluster, a target and current number of entities 610 and key performance indicators (KPIs) 612. The KPIs may include current location count, gross margin, sales cost, sales revenue, sales units, and open-to-buy units. The second window 604 may present a list of entities 616 in the cluster of entities 608. For each entity 616, the second window 604 may present a location identification 618, a geographical location 620, a reference 622, and/or KPIs 624. The KPIs 624 of the second window 604 and the KPIs 612 of the first window 602 may be the same, with the exception being that first window provides the KPIs for the entities clustered together and the second window provide the KPIs for the entities on an individual basis.

The third window 606 may present a plot graph of a plurality of business metrics for each cluster. The user may select a business metric for the “Y” axis of the graph and a business metric for the “X” axis of the graph. In some embodiments, the business metrics of the first window 602, the second window 604, and the third window 606 may be the same. For example, the business metrics may include a “Gross Margin (Referenced),” “Gross Margin %” (Referenced),” “Sales Cost (Referenced),” “Sales Units (Referenced),” and “Capacity.”

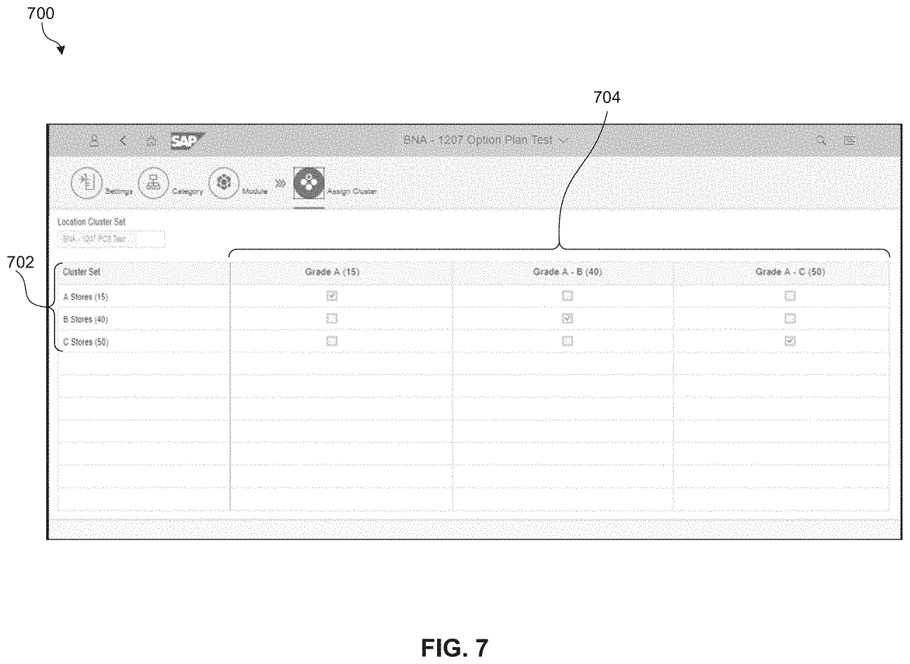

FIG. 7 illustrates an interface 700 for specifying the modules with respect to the entities. The interface 700 may provide clusters of entities 702 and modules 704. The modules may be predefined, for example, by the business professional and/or the planner. As stated above, modules 704 may represent different groups of objects. For example, Grades A, B, and C may represent high, medium, and low priced objects, respectively. As such, when creating an assortment of objects, the planner may assign objects to the modules. Accordingly, the interface 700 may permit a user to indicate which modules 704 are to be made available in creating assortments of objects for each cluster of entities 702.

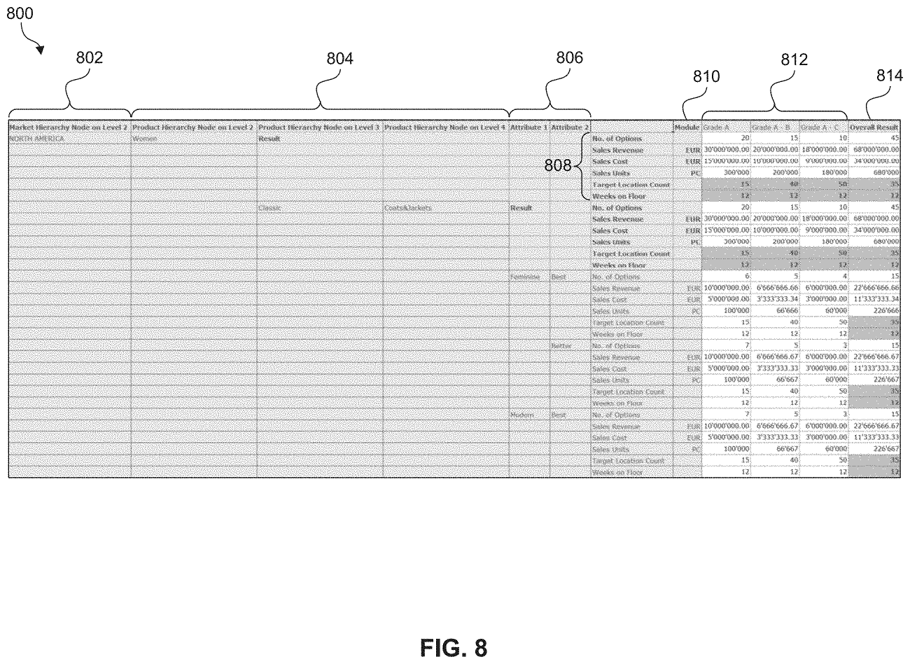

FIG. 8 illustrates an interface 800 for providing a mix of objects for a particular geographical region and/or channel type 802 as described in FIG. 4. As explained above, the entities may be grouped based on the geographical region. As illustrated, the geographical region 802 may be “North America.” Moreover, as also described above, the objects may be grouped and organized in a hierarchy of objects comprising categories, subcategories, segments, sub-segments, etc.

As such, the interface 800 may present the hierarchy of objects 804 available for creating the assortments of objects for the geographical region 802. The interface may also present attributes 806 associated with a node within the hierarchy of objects 806, as well as KPIs 808 associated with each node within the hierarchy of objects 804 and/or each attribute 806 thereof. As illustrated, the hierarchy of objects 804 may include “Classic,” which may comprise “Coats&Jackets.” Moreover, for each node of the hierarchy of objects 804, the interface 800 may include a “Result,” which may combine the outcomes of all nodes in the particular level. The attributes 806 may include “Feminine,” which may include “Best” and “Better,” and “Modern,” which may include “Best” and Better” (not illustrated.)” The KPIs 808 may include “No. of Options,” “Sales Revenue,” Sales Cost,” “Sales Unit,” “Target Location Count,” and “Weeks on Floor.”

Accordingly, the interface 800 may present modules 812 associated to each KPI 808. The interface 800 may permit a business professional and/or planner to input a value for each KPI 808 associated with the modules 812. The values inputted for the KPIs may be aggregated to present a total for the KPI 808 for the higher node in the hierarchy of objects 804. For example, the KPIs inserted for “Feminine” and “Modern” may be aggregated to provide the total for “Coats&Jackets.”

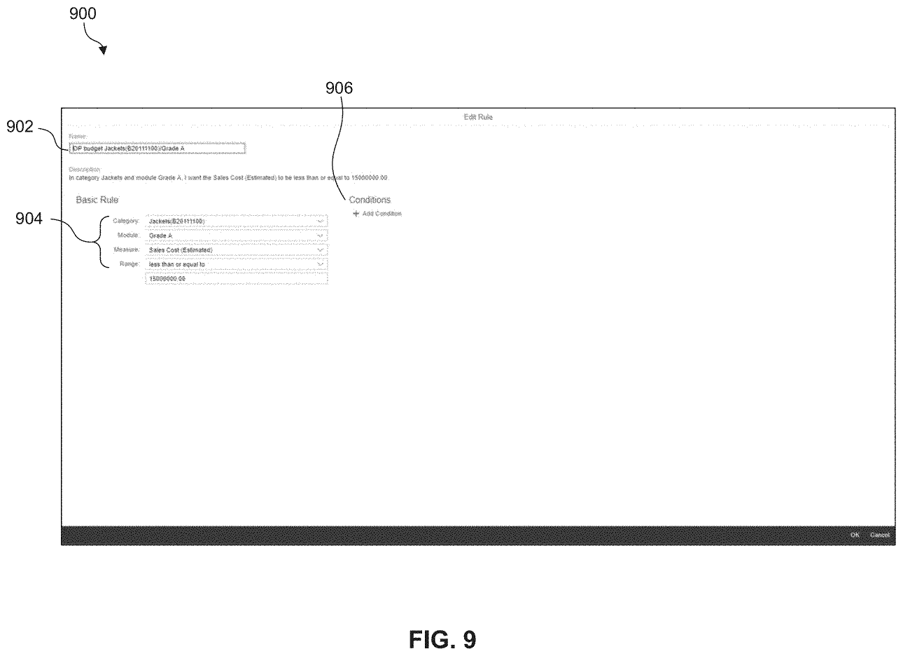

FIG. 9 illustrates an interface 900 for creating and/or editing a rule 904 for digitally creating the assortments of objects. The interface 900 may permit a naming 902 of the rule 904. The rule 904 may be associated with a goal associated with the planner selecting the assortment of objects. As such, the rule 904 may include a category, a module, a measurement, and/or a range. Moreover, the interface 900 may provide a condition 906 for the rule 904.

Accordingly, after completing the process explained in FIGS. 2-9, the planner may create assortments of objects for entities. In doing so, the planner may create various assortments of different types of objects for the entities. For example, the planner may create an assortment of jeans, an assortment of t-shirts, an assortment of jackets, and an assortment shoes. Along these lines, different assortments of objects may include different types of objects for the entities. For example, multiple assortments of objects may each include jeans, t-shirts, jackets, and shoes. Moreover, as stated previously, a module may represent different assortments of objects. As such, the different assortments of objects and modules may represent different aspects of entities (e.g., location, type, genre, goal demographic, goal gender, goal age group, price of the objects).

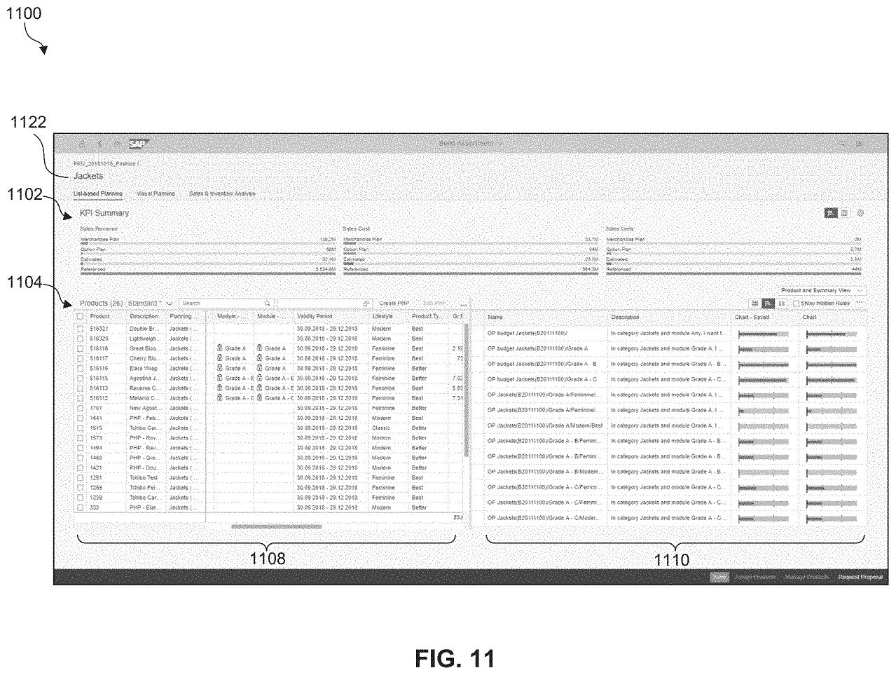

Referring back to FIG. 2, an interface 200 for a planner to create assortments of objects for a particular category 204 is illustrated. The interface 200 may present the objects 206 in an image view 214 or a table view 216 (see FIG. 11). As such, the interface 200 may permit a user to toggle between the image view 214 and the table view 216. As illustrated, when in the image view 214, the interface 200 can permit a user to toggle between a first image view 218 and a second image view 220. The first image view 214 and the second image view 216 can each permit a user to assign goods to modules. Although not illustrated, as will be explained later with respect to FIG. 11, the table view 216 can present an effect that a selection of goods to the modules has on business objectives (e.g., KPIs, organizational boundaries).

As such, the interface 200 can permit a user to quickly switch between the image view 214 and the table view 216. Every change in the assortment made by the user in the image view 214 triggers immediately an update of analytical results or KPIs in table view 216. This can allow the user to select goods and create assortments based on the visual information provided by the image view 214, where the user is guided by a desired emotional effect of the assortment on potential customers, while at the same time and immediately and readily view the effect of their selection on business objectives without the need of a context switch (i.e., a change from one task to another). In doing so, this improves upon convention user interfaces by increasing the efficiency of using devices to view business objectives upon selection of goods.

Still referring to FIG. 2, as stated previously, the interface 200 may include modules 202 and objects 206 available for the planner for assigning to at least one module 202. The modules 202 may each represent a different assortment of objects. As such, the planner may select, drag, and drop a particular image of an object 206 into a module 202. In some embodiments, each object 206 may be assigned to multiple modules 202. Alternatively, each object 206 may be assigned to only one module 202. As such, each module 202 may represent an assortment of objects selected by the planner.

Furthermore, the image view 214 may permit a first image view 218 or a second image view 220. The first image view 218 may present images of the objects 206 arranged in the form of a grid for selection by the planner. The first image view 218 may permit the planner to customize the view by one or more predefined selections 210. In some embodiment, the predefined options may specify the grouping of the objects, the columns of the grid, and the rows of the grid. As illustrated, the objects may be grouped by “Module-Preview,” and the column and row of the grid of objects 206 may be organized by “Product Type” and “Lifestyle,” respectively. Moreover, although not illustrated, the first image view 218 may also strategically display the objects 206 in the grid and/or in the modules 202. The strategic placement may be based on object type and/or object price, For example, hats may be displayed at the top, shirts may be displayed in the middle, and bottoms may be displayed at the bottom.

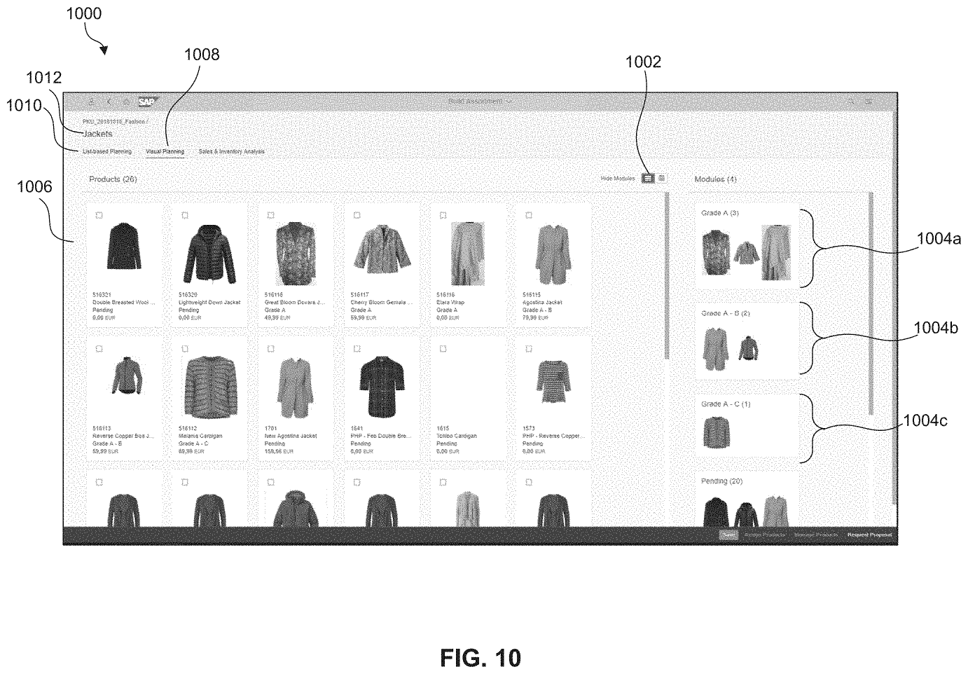

As stated previously, for image view 214, in addition to the first image view 218, the objects 206 may also be presented in a second image view 220. FIG. 10 illustrates an interface 1000 comprising a plurality of objects 1006 of a particular category 1012 displayed in a second image view 1002. The second image view 1002 may present large images of the objects 1006 in the form of a grid. The second image view 1002 may allow the objects 1006 to be added to each module 1004 by selecting their checking boxes and dragging them to the desired module thereof. The modules 1004 may be presented in the same context as the first image view 218 for the image view 214.

Moreover, as explained above, in contrast to the image view 1008, the objects 1006 may also be presented in a table view 1010. FIG. 11 illustrates an interface 1100. The interface 110 can include a table view for a plurality of objects of a particular category 1122. As such, the interface 1100 may include a first window 1102 and a second window 1104. The first window 1102 may provide a table including a list of KPIs relating to the particular category 1122. The KPIs may be based on business goals and/or current outcomes toward the business goals, where the KPIs may be calculated and/or predicted for the objects selected by the planner that makeup the assortments of objects.

The second window 1104 may present a first table 1108 and/or a second table 1110. The first table 1108 may present a list of objects within the category 1122 and properties relating to each object. Properties may include an object number, a description, an image, a selected module, a validity period for availability of the object, a lifestyle of the object, and/or an object type based on quality. The second table 1110 may present a status of fulfilling one or more goals in creating the assortment of objects.

Interface 1100 may be used for list-based planning, where the user is primarily focused on achieving pre-defined numbers or KPIs per assortment. However, it is again possible for the user to immediately see how the list-based planning performed with interface 1100 affects the visual planning side of the assortment, since interface 1100 allows in the same manner as interface 200 of FIG. 2, to directly toggle between the table view of interface 1100 and the corresponding image view of the same assortment and/or of the same categories of objects. Every change in the assortment made by the user in the table view of interface 1100 triggers immediately an update of the grouping of images in image view 214. This can allow the user to select goods and create assortments based on the KPI information provided by the table view 214, where the user is guided by a desired emotional effect of the assortment on potential customers, while at the same time and immediately and readily view the effect of their selection on the visual impression the newly created or changed assortment may have on potential customers, without the need of a context switch (i.e., a change from one task to another). In doing so, analytical and emotion-based planning are seamlessly combined, thus improving upon convention user interfaces by increasing the efficiency of using devices to view business objectives upon selection of goods.

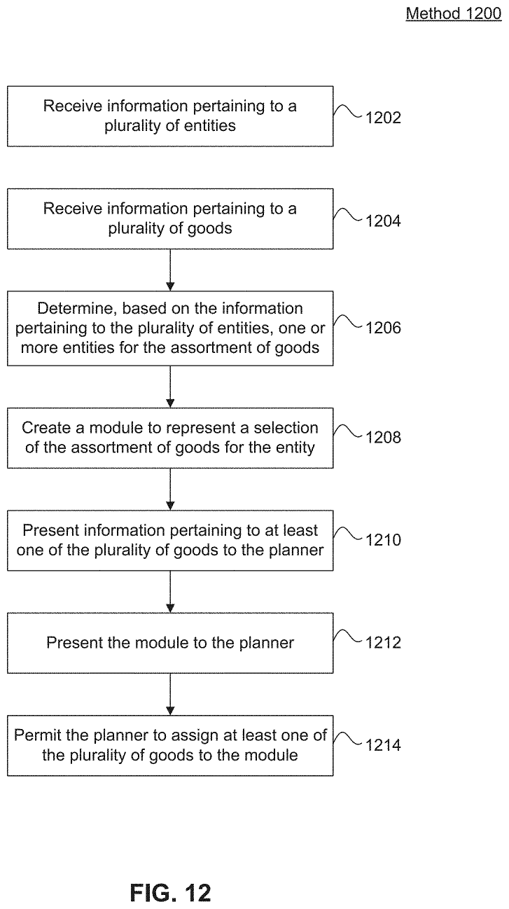

FIG. 12 is a flowchart for a method 1200 for bloom filter cost estimation, according to an embodiment. Method 1200 may be performed by processing logic that may include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 12, as will be understood by a person of ordinary skill in the art.

Method 1200 shall be described with reference to FIG. 2. However, method 1200 is not limited to that example embodiment.

In 1202, a processor may receive information pertaining to a plurality of entities. For example, the processor may receive information relating to one or more categories 204 of each entity. The processor may also receive information relating to a geographical location of each entity.

In 1204, the processor may receive information pertaining to a plurality of objects. For example, the processor may receive an image of the objects 206.

In 1206, the processor may create a first image view presenting images of the plurality of objects and one or more modules representing an assignment of one or more objects to the one or more entities.

In 1208, the processor may create a table view presenting information pertaining to the images of the plurality of objects presented on the first image view and one or more key performance indicators (KPIs) associated with the one or more modules. For example, the processor may create the module 202 that includes a status bar indicative of progress towards a goal based on one more KPIs.

In 1210, the processor may permit the assignment of the at least one of the plurality of objects to the one or more modules such that the one or more modules represent a plurality of assortments of goods. For example, the processor may present the image of the objects 206.

In 1212, the processor may update, based on the assignment of the at least one of the plurality of objects to the one or more modules. The table view may comprise the one or more KPIs.

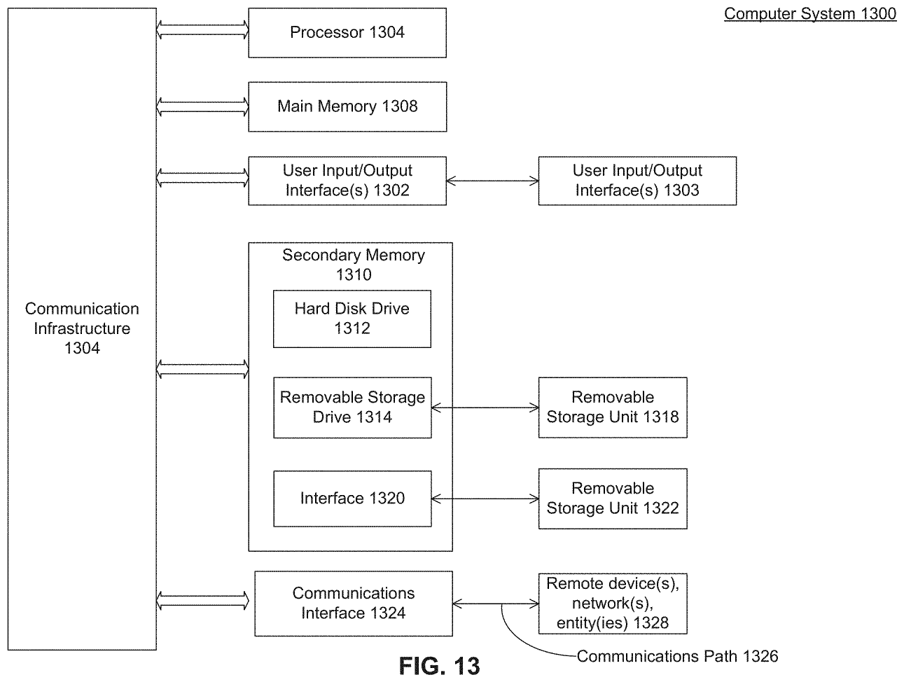

Various embodiments may be implemented, for example, using one or more well-known computer systems, such as computer system 1300 shown in FIG. 13. One or more computer systems 1300 may be used, for example, to implement any of the embodiments discussed herein, as well as combinations and sub-combinations thereof.

Computer system 1300 includes one or more processors (also called central processing units, or CPUs), such as a processor 1304. Processor 1304 is connected to a communication infrastructure or bus 1306.

One or more processors 1304 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1300 also includes player input/output device(s) 1303, such as monitors, keyboards, pointing devices, etc., that communicate with communication infrastructure xx06 through player input/output interface(s) 1302.

Computer system 1300 also includes a main or primary memory 1308, such as random access memory (RAM). Main memory 1308 may include one or more levels of cache. Main memory 1308 has stored therein control logic (i.e., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1314 may be a floppy disk drive, a magnetic tape drive, a compact disk drive, an optical storage device, tape backup device, and/or any other storage device/drive.

Removable storage drive 1314 may interact with a removable storage unit 1318. The removable storage unit 1318 includes a computer usable or readable storage device having stored thereon computer software (control logic) and/or data. Removable storage unit 1318 may be a floppy disk, magnetic tape, compact disk, DVD, optical storage disk, and/any other computer data storage device. Removable storage drive 1314 reads from and/or writes to removable storage unit 1318 in a well-known manner.

According to an exemplary embodiment, secondary memory 1310 may include other means, instrumentalities or other approaches for allowing computer programs and/or other instructions and/or data to be accessed by computer system 1300. Such means, instrumentalities or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1300 may further include a communication or network interface 1324. Communication interface 1324 enables computer system 1300 to communicate and interact with any combination of remote devices, remote networks, remote entities, etc. (individually and collectively referenced by reference number 1328). For example, communication interface 1324 may allow computer system 1300 to communicate with remote devices 1328 over communications path 1326, which may be wired and/or wireless, and which may include any combination of LANs, WANs, the Internet, etc. Control logic and/or data may be transmitted to and from computer system 1300 via communication path 1326.

In an embodiment, a tangible apparatus or article of manufacture comprising a tangible computer useable or readable medium having control logic (software) stored thereon is also referred to herein as a computer program object or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as computer system 1300), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

What is claimed is:

1. A computing system, comprising:
a data interface configured to receive information pertaining to a plurality of entities and information pertaining to a plurality of objects;
at least one processor in communication with the data interface and configured to:
receive the information pertaining to the plurality of entities,
receive the information pertaining to the plurality of objects,
create a first image view presenting images of the plurality of objects and one or more modules representing an assignment of one or more objects to the one or more entities,
create a table view presenting information pertaining to the images of the plurality of objects presented on the first image view and one or more key performance indicators (KPIs) associated with the one or more modules,
permit the assignment of the at least one of the plurality of objects to the one or more modules such that the one or more modules represent a plurality of assortments of goods, and
update, based on the assignment of the at least one of the plurality of objects to the one or more modules, the table view comprising the KPIs.

2. The system of claim 1, wherein the at least one processor is further configured to:
create a second image view presenting images information pertaining to the plurality of objects,
wherein the first image view is different from the second image view.

3. The system of claim 2, wherein the first view and the second view provide different details of the plurality of objects.

4. The system of claim 2, wherein the at least one processor is further configured to:
link the first image view, the second image view, and the third image view to each other, and
present the first image view, the second image view, and the third image view separately from each other.

5. The system of claim 1, wherein the information pertaining to the images of the plurality of objects comprises an aggregated list of the plurality of objects and a status of each of the plurality of objects, wherein the status of each of the plurality of objects relates to whether each object is assigned to the one or more modules.

6. The system of claim 1, wherein the one or more KPIs are unique to the one or more entities.

7. The system of claim 1, wherein each of the one or more modules represents a different one of the one or more entities.

8. The system of claim 1, wherein the processor is further configured to:
determine, based on the information pertaining to the plurality of entities, one or more clusters of entities for the assortment of objects,
wherein each of the one or more modules represents the one or more clusters of entities.

9. The system of claim 1, wherein the one or more modules comprise a plurality of assortments of objects, and wherein the at least one processor is further configured to:
permit the assignment of at least one of the plurality of objects to at least one of the assortment of objects.

10. A computer-implemented method for creating an assortment of objects for one or more entities, comprising:
receiving, by the at least one processor, the information pertaining to the plurality of entities;
receiving, by the at least one processor, the information pertaining to the plurality of objects;
creating, by the at least one processor, a first image view presenting images of the plurality of objects and one or more modules representing an assignment of one or more objects to the one or more entities;
creating, by the at least one processor, a table view presenting information pertaining to the images of the plurality of objects presented on the first image view and one or more key performance indicators (KPIs) associated with the one or more modules,
permitting, by the at least one processor, the assignment of the at least one of the plurality of objects to the one or more modules such that the one or more modules represent a plurality of assortments of goods, and
updating, by the at least one processor and based on the assignment of the at least one of the plurality of objects to the one or more modules, the table view comprising the one or more KPIs,
wherein at least one of the receiving, creating, permitting, and updating is performed by one or more computers.

11. The method of claim 10, further comprising:
creating, by the at least one processor, a second image view presenting images information pertaining to the plurality of objects,
wherein the first image view is different from the second image view.

12. The method of claim 11, wherein the first view and the second view provide different details of the objects.

13. The method of claim 12, further comprising:
linking, by the at last one processor, the first image view, the second image view, and the third image view to each other, and
presenting, by the at least one processor, the first image view, the second image view, and the third image view separately from each other.

14. The method of claim 10, wherein the information pertaining to the images of the plurality of objects comprises an aggregated list of the plurality of objects and a status of each of the plurality of objects, wherein the status of each of the plurality of objects relates to whether each object is assigned to the one or more modules.

15. The method of claim 10, wherein the one or more KPIs are unique to the one or more entities.

16. The method of claim 10, wherein each of the one or more modules represents a different one of the one or more entities.

17. The method of claim 10, further comprising:
determining, by the at least one processor and based on the information pertaining to the plurality of entities, one or more clusters of entities for the assortment of objects,
wherein each of the one or more modules represents the one or more clusters of entities

18. The method of claim 10, wherein the one or more modules comprise a plurality of assortments of objects, and further comprising:
permitting, by the at least one processor, the assignment of at least one of the plurality of objects to at least one of the assortment of objects.

19. A non-transitory computer-readable device having instructions stored thereon that, when executed by at least one computing device, cause the at least one computing device to perform operations comprising:
receiving the information pertaining to the plurality of entities;
receiving the information pertaining to the plurality of objects;
creating a first image view presenting images of the plurality of objects and one or more modules representing an assignment of one or more objects to the one or more entities;
creating a table view presenting information pertaining to the images of the plurality of objects presented on the first image view and one or more key performance indicators (KPIs) associated with the one or more modules;
permitting the assignment of the at least one of the plurality of objects to the one or more modules such that the one or more modules represent a plurality of assortments of goods; and
updating, based on the assignment of the at least one of the plurality of objects to the one or more modules, the table view comprising the one or more KPIs.

20. The non-transitory computer-readable device of claim 18, wherein the instructions cause the at least one computing device to perform operations comprising:
creating a second image view presenting images information pertaining to the plurality of objects;
linking the first image view, the second image view, and the third image view to each other; and
presenting the first image view, the second image view, and the third image view separately from each other,
wherein the first image view is different from the second image view.
